(19) United States
(12) Patent Application Publication
(10) Pub. No.: US 2003/0097292 A1
(43) Pub. Date: May 22, 2003

(54) SYSTEM AND METHOD FOR STABILITY ANALYSIS OF PROFITABILITY OF TARGET MARKETS FOR GOODS OR SERVICES

(75) Inventors: YU-TO CHEN, NISKAYUNA, NY (US); JEREMIAH FRANCIS DONOGHUE, BALLSTON LAKE, NY (US); PIERO PATRONE BONISSONE, SCHENECTADY, NY (US); MARGARET STEWART TRENCH, SCOTIA, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: Christopher L Bernard

(21) Appl. No.: 09/444,659

(22) Filed: Nov. 22, 1999

Related U.S. Application Data
(60) Provisional application No. 60/156,754, filed on Sep. 30, 1999.

(51) Int. Cl. G06F 17/60

(52) U.S. Cl. 705/10

(57) ABSTRACT

This disclosure describes a system and method for providing stability analysis of profitability calculations of target markets for goods or services. The system and method of this disclosure uses an internal experience database and external demographic databases. The system and method evaluates demographic data and calculates the risk associated with a variety of different goods or services. The system and method comprises a number of steps. First, a data acquisition module associates descriptor variables with different goods or services in a portfolio of goods or services. Second, a risk model module processes the various goods or services into distinct groups based upon specified characteristics. The risk model module also calculates risk values for the various goods or services and sorts the portfolio of goods or services into specified categories. Third, a profitability module calculates the net present value of each of the goods or services in the entire portfolio. Finally, a stability analysis module calculates the stability of the profitability for all of the goods or services in the distinct groups based upon specified characteristics.

### CROSS REFERENCE TO RELATED APPLICATIONS

This application claims the benefit of U.S. Provisional Application Serial No. 60/156,754 filed on Sep. 30, 1999, and entitled “System and Method for Stability Analysis of Profitability for Insurance Policies,” which is incorporated by reference herein in its entirety.

### BACKGROUND OF THE INVENTION

This disclosure relates to the profitability of goods or services and more specifically describes a system and method to estimate the stability of profitability of target markets for goods or services.

Generally, estimating the profitability of, for example an insurance product, comprises the steps of deriving demographic variables from an insurance portfolio, applying a risk model to the insurance portfolio, and calculating the net present value of the insurance portfolio.

Cost-conscious direct marketers use their knowledge about persons identified on a mailing list, an e-mail list, or phone list (i.e., a prospect) to identify the best prospects to receive mail. Usually, a marketer will use a set of descriptor variables about each prospect, such as for example, demographics and credit card ownership, to target good prospects (i.e., prospects that will find the mailing interesting). For example, the Rao and Steckel model includes acquiring a set of descriptor variables and conducting a knowledge engineering session to screen the variables. In this regard, a marketing committee may be appointed, and prior experience and intuition may be used to pick out the demographic variables most relevant to the response rate. A risk module scores and segments the entire portfolio of goods or services, for example insurance policies, into a number of categories that can be sorted from low risk to high risk.

A profitability calculation can be performed utilizing the demographic variables acquired during data acquisition and figures of the market segments regarding risk. The value of the current risk is projected over the expected life of the good or service. In general, the traditional net present value calculation is [Net Present Value=Initial Investment Amount+(Expected Payoff at year X/(1+Discount Factor))].

Currently, it is possible to estimate the profitability scores for each market segment; however, there is a problem of determining accuracy or stability of the profitability calculations of target markets for goods or services.

Thus, there is a particular need for a system to estimate the stability, or accuracy, of profitability scores of target markets for different goods or services.

### BRIEF SUMMARY OF THE INVENTION

This disclosure describes a system and method for stability analysis of profitability for different types of target markets for goods or services. Briefly described, in architecture, the system can be implemented as follows. Data acquisition circuitry acquires a list of goods and services and attaching descriptor variables to the list of goods and services. A risk model logic selects a model for examining the list of goods or services and the descriptor variables. A profitability logic calculates a profitability for the list of goods or services and the descriptor variables examined with the model. Finally, a stability analysis logic calculates a stability of the profitability for the goods or services in the list of goods or services.

This disclosure can also be viewed as describing a method for providing stability analysis of profitability for different types of goods or services. In this regard, the method can be broadly summarized by the following steps: acquiring a list of goods or services and attaching descriptor variables to the list of goods or services; examining the list of goods or services and the descriptor variables with a model; calculating a profitability for the list of goods or services and the descriptor variables examined with the model; and calculating the stability of the profitability for the goods or services in the list of goods or services.

These goods or services can be, but are not limited to, insurance policies, retail goods, on-line merchandise, and other goods or services.

Other features and advantages of this disclosure will become apparent to one with skill in the art upon examination of the following drawings and detailed description. It is intended that all such additional features and advantages be included herein within the scope of the present invention.

### BRIEF DESCRIPTION OF THE DRAWINGS

This disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an example of the profitability stability analysis system using an example of different insurance policies, situated within a computer readable medium, in a computer system.

FIG. 2 is a block diagram illustrating an example of the profitability stability analysis system for an example of different insurance policies.

FIG. 3 is a flow chart illustrating an example of the process flow of the system and method for stability analysis of profitability for an example of different types of insurance policies.

FIG. 4 is a block diagram illustrating an example of different types of demographic data that can be utilized to construct risk and profitability models as shown in FIGS. 2 and 3.

FIG. 5 is a block diagram of an example illustrating the use of regression trees 5 in risk modeling for an example of different insurance policies, as shown in FIGS. 2 and 3.

FIG. 6 is a flow chart of an example of a profitability calculation process used in the system and method for stability analysis of profitability of the present invention, for an example of insurance policies, as shown in FIGS. 2 and 3.

FIG. 7 is a flow chart of an example of the stability analysis process in the system and method for stability analysis of profitability of the present invention, for the example of insurance policies, as shown in FIGS. 2 and 3.

FIG. 8 is a flow chart of an example of the process that calculates the net present value for each of the N-sample policies in the samples using replacement of the present invention, as shown in FIG. 7.

FIG. 9 is table of an example of a result for the stability analysis process for a universe of Donnelley demographic groups using the example of insurance policies, as illustrated in FIG. 5.

### DETAILED DESCRIPTION OF THE INVENTION

Reference will now be made in detail to the description of the invention as illustrated in the drawings. Although the invention will be described in connection with these drawings, there is no intent to limit it to the embodiment or embodiments disclosed therein. On the contrary, the intent is to include all alternatives, modifications, and equivalents included within the spirit and scope of the invention as defined by the appended claims.

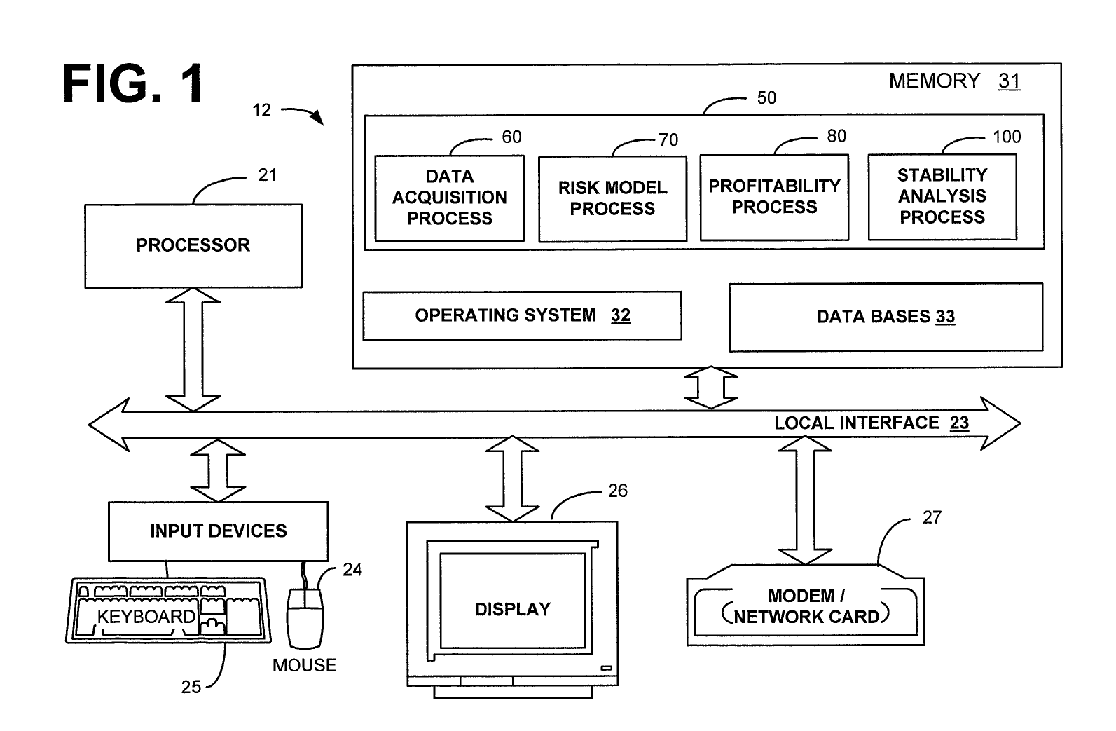

As illustrated in FIG. 1, computer system 12 generally comprises a processor 21 and memory 31 (e.g., RAM, ROM, hard disk, CD-ROM, etc.) with an operating system 32. The processor 21 accepts code and data from the memory 31 over the local interface 23, for example, a bus(es). Direction from the user can be signaled by using input devices, for example but not limited to, a mouse 24 and a keyboard 25. The actions input and resulting output are displayed on the display terminal 26. A profitability stability analysis system 50 can access other computers and resources on a network utilizing modem or network card 27.

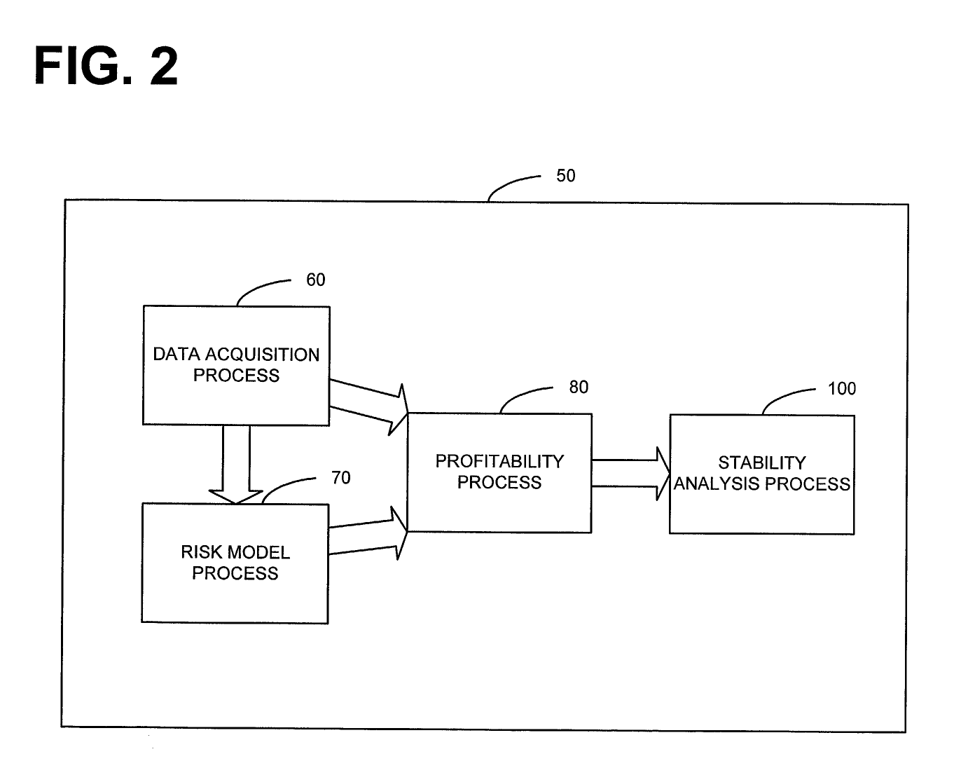

Also shown in FIG. 1 is a data acquisition process 60, a risk model process 70, a profitability process 80, and a stability analysis process 100 in memory area 31. Databases 33 are also shown to reside in memory area 31. These components are herein described in further detail with regard to FIGS. 2-8. The memory area 31 can be, for example but not limited to, an electronic, magnetic, optical, electromagnetic, infrared, or semiconductor system, apparatus, device, or propagation medium. More specific examples (a non-exhaustive list) of the memory area 31 include any one or more of the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

Illustrated in FIG. 2 is an example of the system and method for stability analysis of profitability of target markets for goods or services 50 of this disclosure. The following description of the system and method for stability analysis of profitability of target markets for goods or services 50 uses the example of insurance policies as the goods or services in the portfolio. The portfolio of goods or services can be, but are not limited to, insurance policies, coupons, mass mailing, inserts, and fliers.

The system and method for stability analysis of profitability of target markets for goods or services 50, includes the data acquisition process 60 that comprises the step of acquiring data (i.e., a portfolio of goods or services). The data acquisition process 60 employs a divide and conquer approach to handling massive amounts of demographic data. The demographic data is then input into the risk model process 70 that scores and segments the entire portfolio of goods or services into a number of categories. These categories include a number of different properties that allow sorting to be performed on a variety of different properties for each data type. An example of one property is the associated risk.

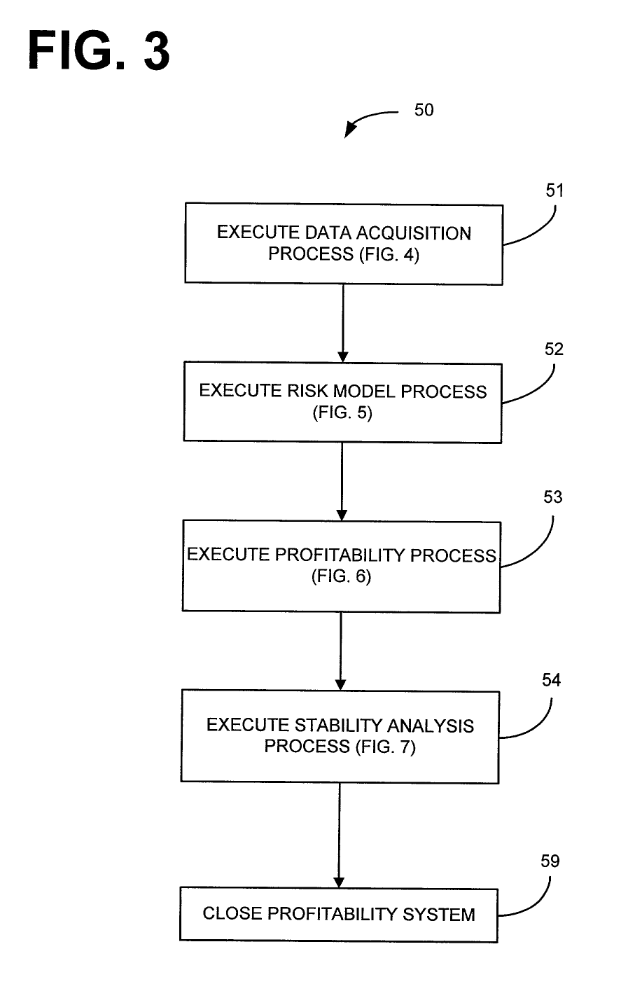

The demographic data collected in the data acquisition process 60 and the risk data computed by the risk model process 70 are both input into the profitability process 80. The profitability process 80 calculates the net present value of each good and service (i.e., policy) recorded in the data acquisition process 60. Once the profitability or net present value of each good and service (i.e., policy) is computed by the profitability process 80, the output is then input into the stability analysis process 100 to estimate the standard error of the net present value calculation for each of the categories determined in the risk model process 70. The data acquisition process 60, risk model process 70, profitability process 80, and stability analysis process 100 are hereindefined described in further detail with regard to FIGs. 3-8.

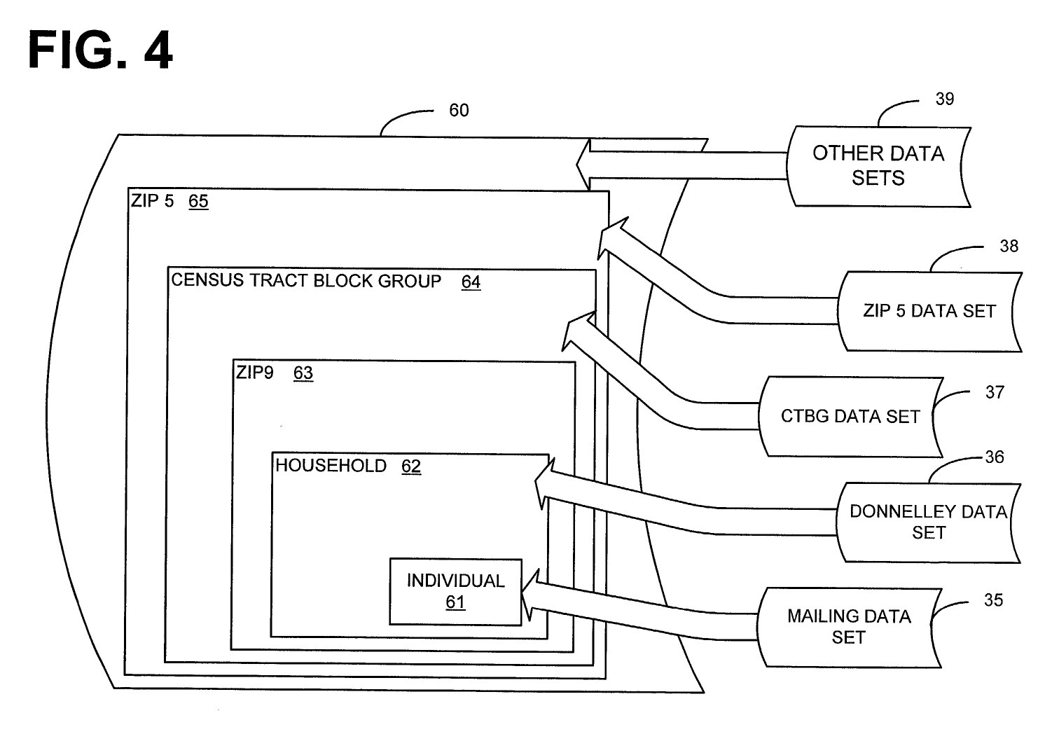

Illustrated in FIG. 3 is a flow chart of an example of a stability analysis of profitability of target markets for goods or services 50. First, the stability analysis of profitability of target markets for goods or services 50 executes the data acquisition process 60 at step 51. The data acquisition process 60 is hereindefined in further detail with regard to FIG. 4.

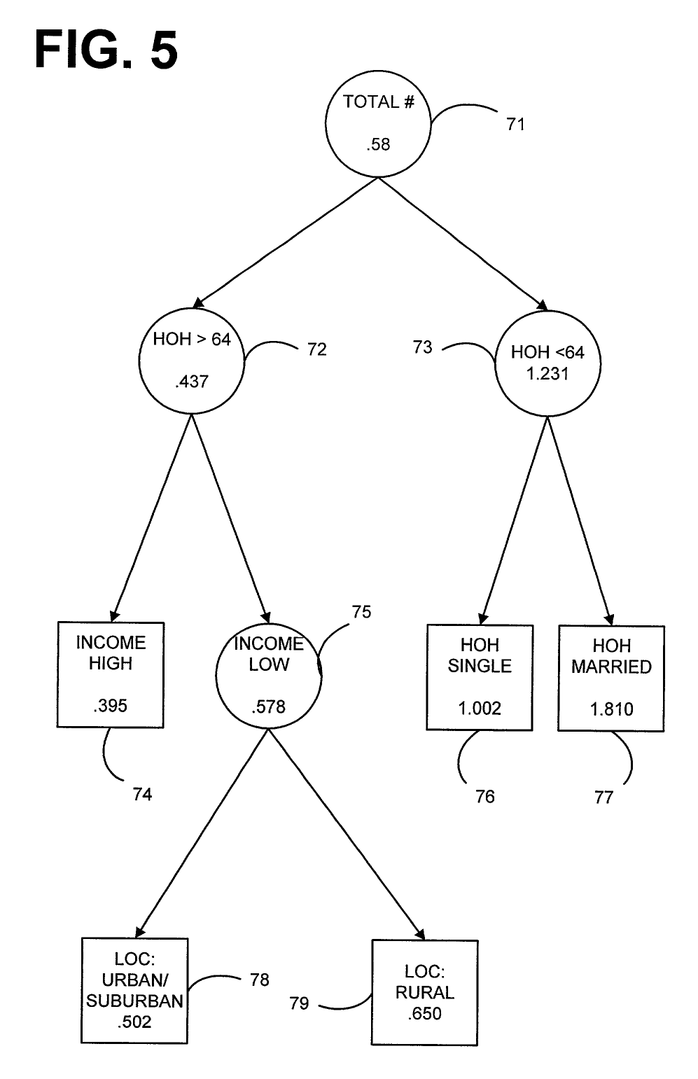

The stability analysis of profitability of target markets for goods or services 50 next executes the risk model process 70 at step 52. The risk model process 70 utilizes demographic data captured in the data acquisition process 60. The risk model process 70 is hereindefined in further detail with regard to FIG. 5.

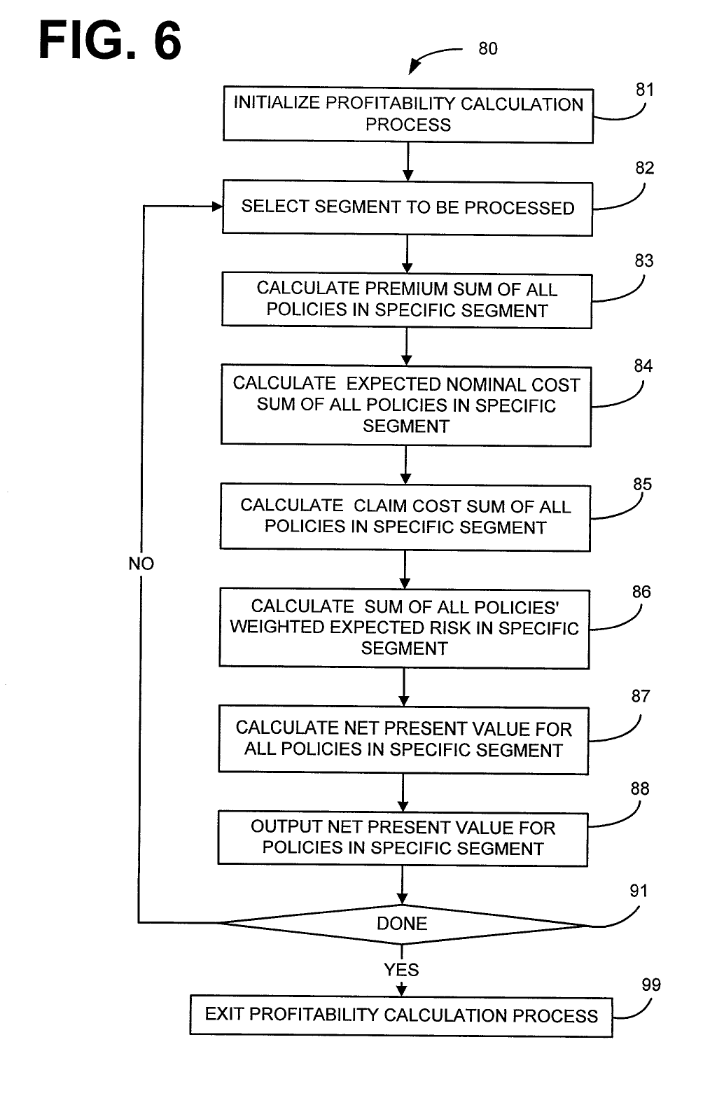

The profitability process 80 is executed at step 53. The profitability process 80 utilizes the demographic data acquired by the data acquisition process 60 and the risk analysis data created by the risk model process 70. The profitability process 80 is hereindefined in further detail with regard to FIG. 6.

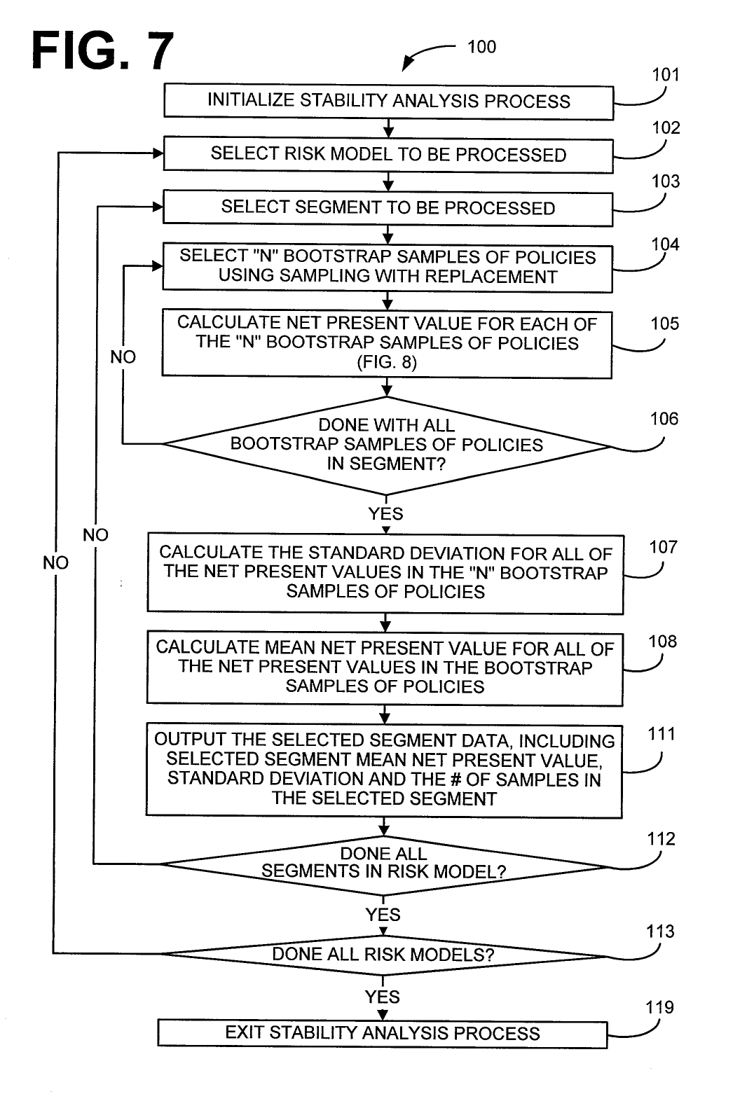

The stability analysis process 100 is executed to determine the accuracy of the profitability data created by the profitability process 80. The stability analysis process 100 is hereindefined in further detail with regard to FIGS. 7 & 8. The stability analysis of profitability of target markets for goods or services 50 then exits at step 59.

Illustrated in FIG. 4 is a block diagram illustrating example types of demographic databases utilized to build the disclosed risk model. The data acquisition process 60 includes the step of acquiring goods or services related data. This step generally comprises attaching data description to goods or services. This disclosure will illustrate these concepts using an insurance example discussed throughout this disclosure. Using this example, the household or area level demographics is attached to a policy holder. First, policy holders dataset 35 records on a policy list are cross referenced with a universal file 60 (i.e., the entire data set) so that information regarding demographic variables associated with a policy holder's record are attached to the policy holder's record. Preferably, the policy holders dataset 35 records are cross-referenced with multiple universal files. For example, as shown in FIG. 4, the policy holders dataset 35 records can be broken down into groups using universal files available from various vendors, including for example Donnelley 36, Census Tract, and Block Group (“CTBG”) 37 and ZIPS 38. If multiple universal files are used, preferably the policy holders dataset 35 records are broken down in to subgroups.

Preferably, the policy holders dataset 35 record is attached with individual 61, household 67 and zip9 area 63 level demographic information, which are useful for identifying segments.

The data acquisition process 60 next comprises the step of variably selecting descriptor variables. Generally, it is desirable to use as few variables as possible in the presence of noise. This is often referred to as the “principle of parsimonious.” There may be combinations (linear or nonlinear) of variables that are irrelevant to the underlying process that, due to noise in data, appear to increase the prediction accuracy. Preferably, variables with the greater discrimination power in response prediction are selected. Generally, descriptor variables are selected using the misclassification rate as a measure of the discrimination power of each input variable given the same size of tree it constructs. The descriptor variables are disclosed by the method for modeling mail response rates described in commonly assigned and co-pending U.S. patent application entitled “METHOD FOR MODELING MARKET RESPONSE RATES”, Attorney Docket Number RD-26,419, Ser. No. 09/396,599 filed on Sep. 15, 1999, herein incorporated by reference.

Illustrated in FIG. 5 is an example of a risk model created during the risk model process 70 with regard to the insurance policies example. One example of a risk model applied by the risk model process 70 is CART. CART is a well known statistical algorithm of regressive trees and is used for risk modeling. The idea behind the regression trees is to filter out potentially high risk goods or services (i.e., insurance policies) up front by partitioning policies into a number of categories such that each category is homogenous in the sense of risk. In addition, the risk model CART process also attaches to each category a unique set of goods or services (i.e., policy) characteristics. As a result, the set of goods or services (i.e., insurance policy) characteristics can be used as filtering criteria in the future.

An example is illustrated in FIG. 5. The real number in each node represents a weighted, expected risk factor for the goods or services. In the insurance policies example utilized in this disclosure, the weighted, expected risk factor is constructed utilizing the formula of A/Ew. “A” represents the actual claim amount and “Ew” is the weighted, expected claim for a specific category. A low A/Ew means a low risk policy while a high A/Ew indicates a high-risk policy. As previously discussed, FIG. 5 is an insurance policy example demonstrating the characteristics of Donnelley demographic data utilizing the properties of age, marital status, and income level of the head of household.

In this example in FIG. 5, 490K real cases from the long-term care policy and claims experience files are used. The cut off date for the file was February 1997. The policies included the actual and expected claims costs for these 490K cases. The idea was to take existing policyholders and their “performance measures” defined by their A/Ew ratio from the experience system, and extend the policy variables adding Donnelley household demographics. The results of the model scoring was then to be applied to the current example mail database to provide a mechanism to target demographic groups that would increase the profits while decreasing the risks of insuring a population more likely to have higher than expected claims cost. The 490K cases in the current example have household level demographic data attached to the file. In this example, one is able to match and attach demographic data to 295K of the cases. This example uses CART to analyze this data to build filters that would group the policy holders into branches or bins on the basis of their demographic data in such a way as to provide the best differentiation of morbidity, wherein morbidity is defined as the sum of actual claims cost divided by expected claims cost.

These 295K cases as a whole had a 58% morbidity, which is considered to be very favorable. There remained a significant difference among the subgroups. The CART analysis resulted in the identification of 8 clusters. Four of these clusters had low morbidity and were grouped into one subgroup. This reduced the number of groups to five. The five groups had 40%, 50%, 65%, 100%, and 181% morbidity. Similarly, CTGB and ZIP5 risk models can also be built utilizing the CART methodology.

Shown in item 71 is an example of a Donnelley risk model where the weighted, expected risk for the total amount of policyholders is 0.58. That category is further broken up into the weighted, expected risk where the head of household is less than 64 years old. The risk model process 70 further determines the income level and associated, weighted, expected risk where the head of household is greater than 64 years old in blocks 74 and 75. Respectively, the expected weighted risk for heads of household greater than 64 and with a high-income level of 0.395, as illustrated in item 74. The weighted expected risk for a head of household greater than 64 with a low income level is equal to 0.578, as illustrated in block 75. Further illustrated is the weighted expected risk amount of 0.502 where the head of household is greater than 64 and has a low-income level and resides in a location would be classified as urban and suburban. The weighted expected risk amount for a head of household greater than 64 with low-income and residing in a rural location are illustrated as item 79 and are equal to 0.650.

Illustrated in FIG. 6 is an example of one implementation of the formula for calculating the profitability of a portfolio of goods or services (i.e., a set of insurance policies). The profitability calculation in the past is defined as:

NPV=C0+[C1/(1+r)]

where C0 is the investment at time 0; C1 is the expected payoff at time 1; and r is the discount factor.

In the present invention, the NPV is defined as:

NPV=ΣP−ΣE−(ΣC)×A/(Ew)

where P is the premium (i.e., revenue); E is the expected nominal cost; and C is the goods or services (i.e., claim) cost. In essence, the above equation gives the net income as being the difference of the profit and the weighted expected risk. Note that this summation is across all the policies in a specific segment. Also note that the entire premium had been discounted, but no acquisition costs have been discounted before entering the equation. As a result, there is a profitability score for each category of the universal files.

As noted above, FIG. 6 is a flow chart of an example of a profitability process 80 that can be utilized in the present invention. The profitability process 80 is first initialized at step 81. Next, the specific segment is selected at step 82. In the insurance policies example utilized in this disclosure, this specific segment indicates the characteristic required in an insurance policy for that insurance policy to be included in the summation across all insurance policies in that segment.

Once the specific segment is selected at step 82, the profitability calculation process 80 calculates the premium sum of all the policies in the selected specific segment at step 83. Next, the profitability calculation process 80 calculates the claim cost sum of all the policies within the selected specific segment at step 85. The profitability calculation process 80 calculates the sum of all policies' weighted expected risk in the specific segment selected at step 86.

Once the sum of all the premiums, expected nominal cost, claim cost, and weighted, expected risk summations are calculated in steps 83 through 86, the profitability calculation process 80 then calculates the net present value for all the policies within the selected specific segment at step 87. This net present value for all policies in the specific segment is then output at step 88.

The profitability calculation process 80 then determines if there are not more segments to be processed at step 91. If more segments are to be processed, the profitability calculation process 80 returns to step 82 to select the next specific segment to be processed. If it is determined that there are no more segments to be processed at step 91, the profitability calculation process then exits at step 99.

Illustrated in FIG. 7 is a flow chart of an example for the stability analysis process 100 of the present invention, using the insurance policies example. The stability analysis process 100 is performed in an attempt to determine the accuracy of the data summaries. The stability analysis process is suitable for answering statistical interference that is far too complicated for traditional statistical analysis. The stability analysis process 100 is based upon the idea of sampling with replacement. Specifically, the stability analysis process 100 simulates the distribution of statistical estimates by repeatedly sampling groups of policies with replacement. The stability analysis process 100 estimates the net present value standard error utilizing the following method.

The stability analysis process 100 is first initialized at step 101. Next, the risk model to be utilized by the stability analysis process 100 is selected at step 102. It is contemplated by the inventors that the risk models are, for example but not limited to, the Donnelley, Census Tract and Block Group (CTBG) and ZIP5 risk models. At step 103, the specific segment to be processed within the risk model is selected.

The stability analysis process 100 then selects “N” Bootstrap samples of policies, using sampling with replacement at step 104. Bootstrap samples are known in the art as a computer-based method that is suitable for answering statistical interference questions that are far too complicated for traditional statistical analysis. Bootstrap samples are based upon the idea of sampling with replacement. In particular, bootstrap samples simulate the distribution of statistical estimates by repeatedly sampling with replacement.

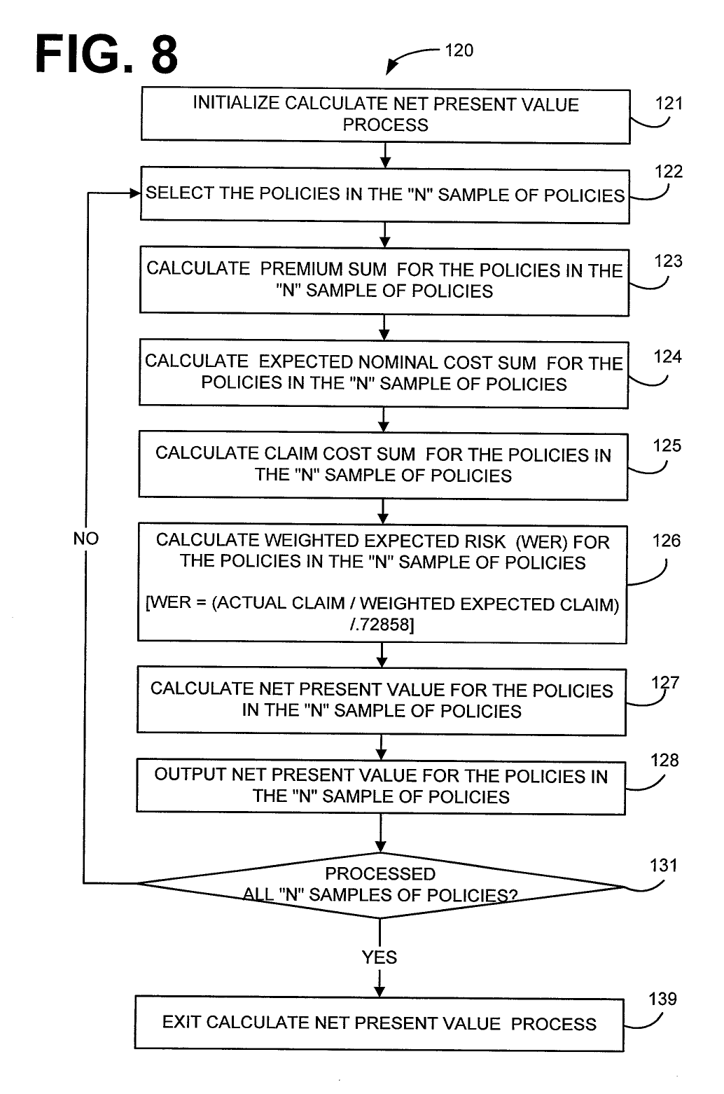

At step 105, the calculation of the net present value for each of the “N” Bootstrap samples of policies using sampling with replacement. This calculation is hereindefined in further detail with regard to FIG. 8. The stability analysis process 100 then determines if all the Bootstrap samples of policies in the selected segment have been processed at step 106. If all the policies in the selected segment have not been processed, the stability analysis process 100 returns to step 104 to select the next segment to be processed.

If it is determined at step 106 that all the Bootstrap samples of policies within a specified segment have been processed, the stability analysis process 100 calculates the standard deviation at step 107. The standard deviation calculated is for all of the net present values determined in step 105. Next at step 108, the stability analysis process 100 calculates the mean net present value for all of the net present values in the Bootstrap samples of policies in the specified segment. At step 111, the stability analysis process 100 outputs the calculated segment data. This data includes but is not limited to the segment number, the net present value of all the policies within a specified segment, the standard deviation of the mean net present value, and the frequency or number of policies in the specified segment.

At step 112, stability analysis process 100 determines if all of the segments in the current risk model have been processed. If there are more segments to be processed in the current risk model, the stability analysis process 100 returns to step 103 to select the next specific segment to be processed. If all the segments have been completed in the current risk model, the stability analysis process 100 then determines if all of the risk models have been processed at step 113. If it is determined that not all the risk models have been processed, the stability analysis process 100 returns to step 102 and selects the next risk model to be processed. If all risk models have been processed, the stability analysis process 100 exits at step 119.

Illustrated in FIG. 8 is the process that calculates the net present value for policies using the insurance policies example in the segment. First, the calculate net present value process 120 is initialized at step 121. Next, the calculate net present value process 120 selects the policies in the “N” sample of policies at step 122.

The calculate net present value process 120 calculates the premium sum for all the policies in the “N” sample of policies at step 123. At step 124, the expected nominal cost sum for the policies in the “N” sample of policies is calculated. The claim cost sum for the policies in the “N” sample of policies is calculated at step 125.

The calculate net present value process 120 then calculates the weighted expected risk value for the policies in the “N” sample of policies at step 126. The weighted expected risk is calculated by using the actual claim amount for policies in a predetermined time period. This amount is divided by the value determined by the weighted expected claim amount for each policy in the predetermined time period divided by the normalization constant 0.72858. The calculate net present value process 120 then utilizes the previous calculations to calculate the net present value for the policies within the “N” sample of policies at step 127. The net present value for the policies in the “N” sample of policies is then output at step 128.

The calculate net present value process 120 then determines if all “N” samples of policies have been processed at step 131. If there are more samples of policies to be processed in the “N” sample of policies, the calculate net present value process 120 then returns to repeat steps 122 through 131. If it is determined at step 131 that all “N” samples of policies have been processed, the calculate net present value process 120 then exits at step 139.

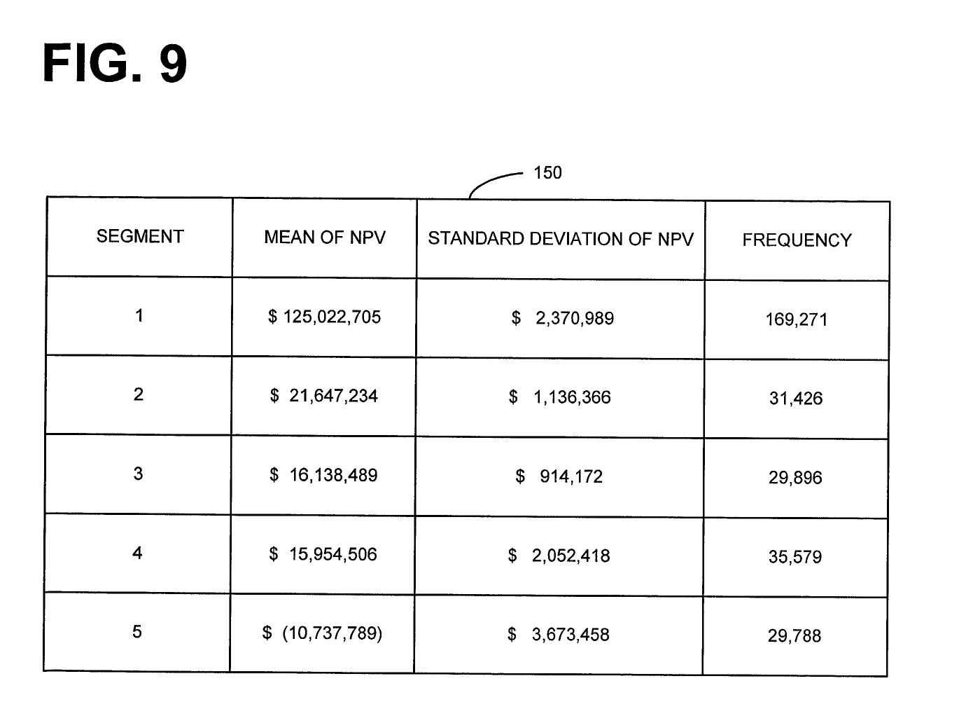

Illustrated in FIG. 9, is a result for the stability estimates of the insurance policies example for a universe of Donnelley demographic groups used in FIG. 5. The segments are arranged from left to right as shown in FIG. 5. Therefore, segment 5 in table 150 represents the left-most category 77 with an A/Ew=1.810. This is a high-risk segment as indicated in its mean of NPV=(−$10,737,789) and a standard deviation of the mean of the net present value=$3,673,458. One useful bit of information coming from table 150 is the standard deviation. The standard deviation can be used to explain the level of variability in the group and establish a confidence interval to assign individuals to that category correctly. The values from the mean of plus and minus three standard deviations explain 99 percent of the variability. This is used to determine if two segments are too close, i.e., whether they are at least three times the standard deviation away from one another.

If the segments are at least three times the standard deviation away from one another, it can be concluded that the segments (i.e., buckets) generated by a particular risk model are fairly stable in their means. In other words, it provides the standard error of the statistics of interest, (i.e., that mean of the NPV for each segment of the risk models).

An example comparison of segments three (3) and four (4) will now be made. In segment 4, the mean of the net present value is $15,954,506, and a standard deviation of $2,052,418. Three times the standard deviation in segment 4 is equal to $6,157,254. Plus or minus three times the standard deviation of the mean at the net present value is equal to $22,111,760 and $9,797,252. These values are then compared with segment 3 having a mean of the net present value equal to $16,138,489 and a standard deviation of $914,172. Plus or minus three times the standard deviation of segment 3 having the mean of the net present value is equal to $17,052,661 and $15,224, 317. In this example, the range covered by three times the standard deviation of the mean of the net present value for segment 4 completely envelopes three times the standard deviation of the mean of the net present value for segment 3. This would lead one to the conclusion that segments three and four are too close and therefore should be merged.

Another example of an application for the stability analysis for profitability of goods or services 50 of the present invention is in the field of retail sales. The stability analysis for profitability of goods or services system 50 can be used to determine the profitability of target markets for goods or services.

The method and system for the stability analysis for profitability of target markets for goods or services 50 comprise an ordered listing of executable instructions for implementing logical functions. The ordered listing can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

The foregoing description has been presented for purposes of illustration and description. It is not intended to be exhaustive or to limit the invention to the precise forms disclosed. Obvious modifications or variations are possible in light of the above teachings. The flow charts of this disclosure show the architecture, functionality, and operation of a possible implementation of the register usage optimization compilation and translation system. In this regard, each block represents a module, segment, or portion of code, which comprises one or more executable instructions for implementing the specified logical function(s). It should also be noted that in some alternative implementations, the functions noted in the blocks may occur out of the order noted in the figures, or for example, may in fact be executed substantially concurrently or in the reverse order, depending upon the functionality involved.

The system and methods discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A method for providing stability analysis of profitability for different types of goods or services products comprising the steps of:
acquiring a list of products and attaching descriptor variables to said list of goods or services;
examining said list of products and said descriptor variables with a model;
calculating a profitability for said list of products and said descriptor variables examined with said model; and
calculating a stability of said profitability.

2. The method of claim 1, wherein said step of calculating said stability of said profitability comprises:
selecting the number of samples in said list of products and said descriptor variables examined with said model to be processed; and
calculating a net present value for each of the number of samples selected.

3. The method of claim 2, wherein said step of calculating said net present value comprises:
calculating a premium sum for all of the number of samples selected;
calculating expected nominal cost sum for all of the number of samples selected;
calculating a products cost sum for all of the number of samples; and
subtracting said expected nominal cost sum and said products cost sum from said premium sum.

4. The method of claim 3, wherein said step of calculating said products cost sum comprises:
calculating a weighted expected products cost risk amount for each of the number of samples selected in a predetermined time period.

5. The method of claim 4, wherein said step calculating said weighted expected products cost risk amount comprises:
calculating actual products cost for each of the number of samples selected in a predetermined time period;
calculating weighted expected products amount for each of the number of samples selected in a predetermined time period; and
dividing said actual products cost by said weighted expected products amount.

6. The method of claim 5, wherein said step of calculating weighted expected products amount further comprises:
dividing said weighted expected products amount by a normalization constant.

7. The method of claim 2, wherein said step of calculating the stability of said profitability further comprises:
calculating a standard deviation of the net present value for all of the number of samples selected.

8. A system for providing stability analysis of profitability for different types of goods or services products comprising:
means for acquiring a list of products and attaching descriptor variables to said list of products;
means for examining said list of products and said descriptor variables with a model;
means for calculating a profitability for said list of products and said descriptor variables examined with said model; and
means for calculating a stability of said profitability.

9. The system of claim 8, wherein said calculating said stability of said profitability means comprises:
means for selecting the number of samples in said list of products and said descriptor variables examined with said model to be processed; and
means for calculating a net present value for each of the number of samples selected.

10. The system of claim 9, wherein said calculating net present value means further comprises:
means for calculating a premium sum for all of the number of samples selected;
means for calculating an expected nominal cost sum for all of the number of samples selected;
means for calculating a products cost sum for all of the number of samples selected; and
means for subtracting said expected nominal cost sum and said products cost sum from said premium sum.

11. The system of claim 10, wherein said calculating products cost sum means further comprises:
means for calculating a weighted expected products cost risk amount for each of the number of samples selected in a predetermined time period.

12. The system of claim 11, wherein said calculating said weighted expected products cost risk amount means further comprises:
means for calculating actual products cost for each of the number of samples selected in a predetermined time period;
means for calculating weighted expected products amount for each of the number of samples selected in a predetermined time period; and
means for dividing said actual products cost by said weighted expected products amount.

13. The system of claim 12, wherein said calculating weighted expected products amount means further comprises:
means for dividing said weighted expected products amount by a normalization constant.

14. The system of claim 9, wherein said calculating stability of profitability means further comprises:
means for calculating a standard deviation of the net present value for all of the number of samples selected.

15. A system for providing stability analysis of profitability for different types of goods or services products comprising:
data acquisition logic acquires a list of products and attaching descriptor variables to said list of goods or services;
risk model logic selects a model for examining said list of products and said descriptor variables;
profitability logic calculates a profitability for said list of products and said descriptor variables examined with said model; and
stability analysis logic calculates a stability of said profitability.

16. The system of claim 15, wherein said stability analysis logic further comprises:
a samples selection logic that selects the number of samples in said list of products and said descriptor variables examined with said model to be processed; and
a net present value logic that calculates a net present value for each of the number of samples selected.

17. The system of claim 16, wherein said net present value logic further comprises:
a premium logic that calculates a premium sum for all of the number of samples selected; and
an expected nominal cost logic that calculates an expected nominal cost sum for all of the number of samples selected.

18. The system of claim 17, further comprising:
a weighted expected products cost logic for calculating a weighted expected is products cost sum for each of the number of samples selected in a predetermined time period; and
a subtracting logic that subtracts said weighted expected products cost sum and said expected nominal cost sum from said premium sum to compute said net present value.

19. The system of claim 18, wherein said weighted expected products cost logic further comprises:
an actual products cost logic that calculates actual products cost for each of the number of samples selected in a predetermined time period;
an weighted expected products cost logic that calculates weighted expected products amount for each of the number of samples selected in a predetermined time period; and
a first dividing logic that divides said actual products cost by said weighted expected products cost to compute a weighted expected products amount.

20. The system of claim 19, further comprises:
a first dividing logic that divides said weighted expected products amount by a normalization constant to compute said net present value.

21. The system of claim 16, wherein said stability analysis logic further comprises:
a standard deviation logic means for calculating a standard deviation of the net present value for all of the number of samples selected.

22. A computer readable recording medium having a program providing stability analysis of profitability for different types of goods or services products, said program comprising:
means for acquiring a list of products and attaching descriptor variables to said list of products;
means for examining said list of products and said descriptor variables with a model;
means for calculating a profitability for said list of products and said descriptor variables examined with said model; and
means for calculating a stability of said profitability.

23. The computer readable medium of claim 22, wherein the means for calculating said stability of said profitability includes:
a first routine selecting the number of samples in said list of products and said descriptor variables examined with said model to be processed; and
a second routine means for calculating a net present value, for each of the number of samples selected.

24. The computer readable medium of claim 23, wherein the means for calculating said stability of said profitability further includes:
a third routine means for calculating a premium sum for all of the number of samples selected;
a fourth routine means for calculating expected nominal cost sum for all of the number of samples selected;
a fifth routine means for calculating products cost sum for all of the number of samples selected; and
a sixth routine means for subtracting said expected nominal cost sum and said products cost sum from said premium sum (127).

25. The computer readable medium of claim 24, wherein the means for calculating said stability of said profitability further includes:
a seventh routine means for calculating a weighted expected products cost risk amount for each of the number of samples selected in a predetermined time period.

26. The computer readable medium of claim 25, wherein the means for calculating said stability of said profitability further includes:
an eight routine means for calculating actual products cost for each of the number of samples selected in a predetermined time period;
a ninth routine means for calculating weighted expected products amount for each of the number of samples selected in a predetermined time period; and
a tenth routine means for dividing said actual products cost by said weighted expected products amount.

27. The computer readable medium of claim 26, wherein the means for calculating said stability of said profitability further includes:
an eleventh routine means for dividing said weighted expected products amount by a normalization constant.

28. The computer readable medium of claim 23, wherein said calculating stability of profitability means further includes:
a twelfth routine means for calculating a standard deviation of the net present value for all of the number of samples selected.
